(19) United States
(12) Patent Application Publication
(10) Pub. No.: US 2022/0214732 A1
(43) Pub. Date: Jul. 7, 2022

(54) POWER DELIVERY CONNECTORS

(71) Applicant: Hewlett-Packard Development Company, L.P., Spring, TX (US)

(72) Inventors: Fangyong Dai, Spring, TX (US); Richard Lin, Spring, TX (US); Xiang Ma, Spring, TX (US); Baosheng Zhang, Spring, TX (US)

(73) Assignee: Hewlett-Packard Development Company, L.P., Spring, TX (US)

(21) Appl. No.: 17/608,196

(22) PCT Filed: Sep. 5, 2019
(86) PCT No.: PCT/US2019/049650

§ 371 Date: Nov. 2, 2021

(51) Int. Cl. G06F 1/26

(52) U.S. Cl. CPC G06F 1/26

(57) ABSTRACT

An example power delivery device includes a two-fold rotationally-symmetrical electrical connector with electrical connector pins having power delivery capability. A switch is operatively connected to the two-fold rotationally-symmetrical electrical connector to transmit power through the electrical connector pins. A power delivery controller to (i) identify a first set of electrical connector pins being used for transmission of electrical signals, (ii) identify a second set of electrical connector pins that are not being used for transmission of the electrical signals, and (iii) control the switch for power delivery between a first electrical device and a second electrical device through the first set of electrical connector pins and the second set of electrical connector pins.

### BACKGROUND

Computing devices utilize electrical connectors for various purposes. In one use, electrical connectors transfer power to computing devices. Electrical connectors may limit the amount of power deliverable to computing devices.

### BRIEF DESCRIPTION OF THE DRAWINGS

The following detailed description references the drawings, in which:

FIG. 1 is a block diagram illustrating a power delivery device, according to an example.

FIG. 2A is a schematic diagram illustrating a USB Type-C receptacle side interface, according to an example.

FIG. 2B is a schematic diagram illustrating a USB Type-C plug side interface, according to an example.

FIG. 3A is a schematic diagram illustrating a USB Type-C receptacle side interface with connected MUXs used in the power delivery device of FIG. 1, according to an example.

FIG. 3B is a schematic diagram illustrating a USB Type-C receptacle side interface with a connected MUX used in the power delivery device of FIG. 1, according to an example.

FIG. 3C is a schematic diagram illustrating a USB Type-C AC adapter plug side interface with connected MUXs used in the power delivery device of FIG. 1, according to an example.

FIG. 4 is a block diagram illustrating a power delivery device, according to an example.

FIG. 5 is a block diagram illustrating transmission of power using the power delivery device of FIG. 4, according to an example.

FIG. 6 is a block diagram illustrating communicatively linking the first and second power delivery controllers of FIG. 4, according to an example.

FIG. 7 is a block diagram illustrating exchanging computer-executable instructions between the first and second power delivery controllers of FIG. 4, according to an example.

FIG. 8 is a block diagram illustrating delivering power through a subset of pins that were not previously being used for transmission of electrical signals in the power delivery device of FIG. 4, according to an example.

FIG. 9 is a block diagram illustrating a system for power delivery, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Currently, mobile workstations continue to use big barrel AC adapters as the main power source and typically cannot migrate to type-C AC adapters due to 100 W power limitations. The same situation occurs on Type-C docking stations. Because a type-C cable from a dock station generally cannot meet mobile workstation power requirements, the mobile workstation system requires a barrel AC adapter on the system or to operate in a non-full power state with a Type-C cable. With GND shielding on type-C connector, GND connection is much robust than power (VBUS). The Type-C cable's power delivery is mainly bottlenecked and limited by VBUS's four pins connecting on the Type-C connector. A Type-C connector specifies that each power pin can carry a maximum current of 1.25 A. With four power (VBUS) pins defined on a Type-C connector, power delivery from a Type-C port has a 100 W (20V×5 A) limit. However, 100 W is not sufficient for some systems like mobile workstations with high-end CPUs and GPUs. Rather, 120 W and 150 W may be required on these systems. Due to its high-current demand, there have been challenges to make a Type-C power adapter or develop a Type-C docking station for power delivery to a system that requires over 100 W power input. A method to develop a Type-C AC adapter beyond 100 W power limitations, and a docking station that can deliver more than 100 W to notebook via Type-C power delivery can enhance mobile workstation functionalities.

To facilitate this, pins on a two-fold rotationally-symmetrical electrical connector, such as USB Type-C connector, are provided to have power delivery capability. According to examples herein, a technique is provided to discover and utilize unused pins on the two-fold rotationally-symmetrical electrical connector after an electronic communication link is established between connected electrical devices. Pins that are discovered as unused are selected for delivering power. The examples described herein utilize a power delivery (PD) controller and multiplexer (MUX) on both the host and device sides. Examples of a host/device system include a computer and docking station. By utilizing all of the pins available for use for power delivery, the examples described herein permit an increase in the power delivery capability to beyond 100 W that is USB type-C connector specified. After the Type-C's interface is discovered, a new negotiation or link phase is added between the host and the device power delivery controller so that both can discover and agree on unused pins and agreed to repurpose these as power or GND pins. That permits more power to be delivered through the GND pins without impact anything other operations of the connected components. Therefore, power delivery from a typical Type-C connector can be increased and more power can be introduced into the system. The examples described herein greatly improves the power delivery bottleneck on a Type-C cable and enables 100 W or more power delivery on Type-C cables and connectors. This enables high power delivering beyond 100 W from a docking station, and further makes it possible to have a 200 W Type-C power adapter.

An example provides power delivery device comprising a two-fold rotationally-symmetrical electrical connector comprising electrical connector pins having power delivery capability. A switch is operatively connected to the two-fold rotationally-symmetrical electrical connector to transmit power through the electrical connector pins. A power delivery controller to (i) identify a first set of electrical connector pins being used for transmission of electrical signals, (ii) identify a second set of electrical connector pins that are not being used for transmission of the electrical signals, and (iii) control the switch for power delivery between a first electrical device and a second electrical device through the first set of electrical connector pins and the second set of electrical connector pins. In an example, the two-fold rotationally-symmetrical electrical connector comprises a reversible connector. In an example, the two-fold rotationally-symmetrical electrical connector comprises a Type-C connector. According to an example, the switch comprises a multiplexer. In an example, the power delivery is greater than 100 W.

Another example provides a power delivery device comprising a two-fold rotationally-symmetrical electrical connector comprising a first end and a second end. The two-fold rotationally-symmetrical electrical connector comprises a first set of electrical connector pins positioned at the first end; and a second set of electrical connector pins positioned at the second end. The power delivery device further comprises a first switch operatively connected to the first set of electrical connector pins; a second switch operatively connected to the second set of electrical connector pins; a first power delivery controller to (i) identify the first set of electrical connector pins being used for transmission of electrical signals, and (ii) control the first switch for power delivery to a first electrical device connected at the first end; and a second power delivery controller to (i) identify the second set of electrical connector pins being used for transmission of electrical signals, and (ii) control the second switch for power delivery to a second electrical device connected at the second end.

According to an example, the first power delivery controller is to modify the first switch from transmission of a differential electrical signal to transmission of power. The second power delivery controller is to modify the second switch from transmission of the differential electrical signal to transmission of power. In an example, an arrangement of the first set of electrical connector pins is symmetrical to an arrangement of the second set of electrical connector pins. The first power delivery controller and the second power delivery controller are communicatively linked through the two-fold rotationally-symmetrical electrical connector, in an example. The first power delivery controller and the second power delivery controller are to exchange computer-executable instructions to determine whether the first electrical device and the second electrical device are operationally compatible with each other, in an example. In accordance with an example, the first power delivery controller is to identify a subset of pins of the first set of electrical connector pins that are not being used for transmission of the electrical signals, and deliver power through the subset of pins. According to an example, the second power delivery controller is to identify a subset of pins of the second set of electrical connector pins that are not being used for transmission of the electrical signals, and deliver power through the subset of pins.

Another example provides a machine-readable storage medium comprising computer-executable instructions that when executed cause a first power delivery controller of a first electrical device to identify a first set of electrical connector pins of a two-fold rotationally-symmetrical electrical connector that are being used for transmission of electrical signals; identify a subset of pins from the first set of electrical connector pins that are not being used for transmission of electrical signals; communicate with a second power delivery controller to confirm support for utilizing the electrical signals; control a first switch for power delivery to the first electrical device connected to the first set of electrical connector pins; and deliver power through the subset of pins.

In an example, the instructions, when executed, further cause the second power delivery controller to identify a second set of electrical connector pins of the two-fold rotationally-symmetrical electrical connector that are being used for transmission of the electrical signals. In an example, the instructions, when executed, further cause the second power delivery controller to control a second switch for increasing power delivery to a second electrical device connected to the second set of electrical connector pins.

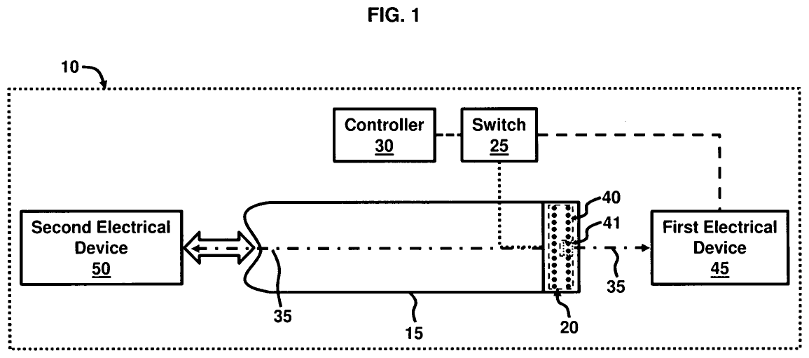

FIG. 1 illustrates a power delivery device 10 comprising a two-fold rotationally-symmetrical electrical connector 15 comprising electrical connector pins 20 having power delivery capability. According to an example, the two-fold rotationally-symmetrical electrical connector 15 comprises a reversible connector. More particularly, in an example, the two-fold rotationally-symmetrical electrical connector 15 comprises a Type-C connector. In an example, the power delivery is greater than 100 W. The electrical connector pins 20 may be any type of male and female type metal pins used to connect to corresponding female or male ports in a corresponding connector, bridge device, or receptacle of an electrical device. There may be any suitable number of electrical connector pins 20 in the two-fold rotationally-symmetrical electrical connector 15. In an example, the electrical connector pins 20 may comprise a first set of electrical connector pins 40 and a second set of electrical connector pins 41. Moreover, there may be any suitable number of pins in each of the first set of electrical connector pins 40 and the second set of electrical connector pins 41. A Type-C connector typically contains two sets of twelve pins arranged in a substantially symmetrical configuration to permit rotational use of the Type-C connector. In other words, the Type-C connector may be used in an upwards or downwards orientation with respect to the positioning of the electrical connector pins 20.

A switch 25 is operatively connected to the two-fold rotationally-symmetrical electrical connector 15 to transmit power through the electrical connector pins 20. The switch 25 may be operatively connected to the electrical connector pins 20. In an example, the switch 25 may be an electrical circuit that may be programmed and controlled using any of analog and digital electrical signals to control operation of the two-fold rotationally-symmetrical electrical connector 15. According to some examples, the switch 25 may be a standalone component or may be part of another system or device, such as a first electrical device 45 or a second electrical device 50.

A power delivery controller 30 is provided to (i) identify a first set of electrical connector pins 40 being used for transmission of electrical signals 35, (ii) identify a second set of electrical connector pins 41 that are not being used for transmission of the electrical signals 35, and (iii) control the switch 25 for power delivery between the first electrical device 45 and the second electrical device 50 through the first set of electrical connector pins 40 and the second set of electrical connector pins 41. In an example, the power delivery controller 30 may be an electrical circuit that may be programmed and controlled using any of analog and digital electrical signals to control operation of the switch 25. According to some examples, the power delivery controller 30 may be a standalone component or may be part of another system or device, such as the first electrical device 45 or the second electrical device 50. In some examples, the power delivery controller 30 may be a central processing unit, microprocessor, microcontroller, proportional-derivative (PD) controller, proportional-integral-derivative (PID) controller, hardware engine, hardware pipeline, and/or other hardware-enabled device suitable for receiving, processing, and operating a set of computer-implemented instructions used to control the switch 25.

The electrical signals 35 may be any type of electrical signals that are transmitted through the two-fold rotationally-symmetrical electrical connector 15, and which can deliver power to an electrical device, such as the first electrical device 45 and the second electrical device 50. For example, the electrical signals 35 may be AC or DC signals. The electrical connector pins 20 are provided to transmit the electrical signals 35 to/from the two-fold rotationally-symmetrical electrical connector 15 to a connected device, such as the first electrical device 45 and/or the second electrical device 50. The power delivery controller 30 may be programmed to identify the electrical connector pins 20 being used for transmission of electrical signals 35 based on whether electrical signals 35 are transmitted through particular ones of the electrical connector pins 20. For example, when electrical signals 35 are transmitted through some of the electrical connector pins 20, then the power delivery controller 30 may detect which of the electrical connector pins 20 are transmitting the electrical signals 35. In an example, the power delivery controller 30 may utilize one or more sensors, not shown, to detect the electrical impulses associated with the electrical signals 35. Furthermore, the power delivery controller 30 may be programmed to identify the first set of electrical connector pins 40 and second set of electrical connector pins 41 that are not being used for transmission of the electrical signals 35. In an example, the power delivery controller 30 may accomplish this by detecting the absence of electrical signals 35 being transmitted through the first set of electrical connector pins 40 and second set of electrical connector pins 41. Additionally, the power delivery controller 30 may be programmed to control the switch 25 to open or close to deliver power between the first electrical device 45 and the second electrical device 50 via the two-fold rotationally-symmetrical electrical connector 15 and through the first set of electrical connector pins 40 and the second set of electrical connector pins 41. For example, when the switch 25 is opened by the power delivery controller 30, the electrical signals 35 may be transmitted through the first set of electrical connector pins 40 and the second set of electrical connector pins 41 that previously; i.e., when the switch 25 is closed, were not transmitting the electrical signals 35. Accordingly, power delivery occurs by the transmission of the electrical signals 35 through the first set of electrical connector pins 40 and the second set of electrical connector pins 41. Because electrical signals 35 are also being delivered through the first set of electrical connector pins 40 and the second set of electrical connector pins 41, the amount of delivered power increases compared to when electrical signals 35 are delivered through the first set of electrical connector pins 40 but not through the second set of electrical connector pins 41, for example.

The various controllers, switches, and circuits described herein and/or illustrated in the figures may be embodied as hardware-enabled modules and may be a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that include electronic circuits process computer logic instructions capable of providing digital and/or analog signals for performing various functions as described herein. The various functions can further be embodied and physically saved as any of data structures, data paths, data objects, data object models, object files, database components. For example, the data objects could include a digital packet of structured data. Example data structures may include any of an array, tuple, map, union, variant, set, graph, tree, node, and an object, which may be stored and retrieved by computer memory and may be managed by processors, compilers, and other computer hardware components. The data paths can be part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be physical locations in computer memory and can be a variable, a data structure, or a function. Some examples of the modules include relational databases (e.g., such as Oracle® relational databases), and the data objects can be a table or column, for example. Other examples include specialized objects, distributed objects, object-oriented programming objects, and semantic web objects. The data object models can be an application programming interface for creating HyperText Markup Language (HTML) and Extensible Markup Language (XML) electronic documents. The models can be any of a tree, graph, container, list, map, queue, set, stack, and variations thereof, according to some examples. The data object files can be created by compilers and assemblers and contain generated binary code and data for a source file. The database components can include any of tables, indexes, views, stored procedures, and triggers.

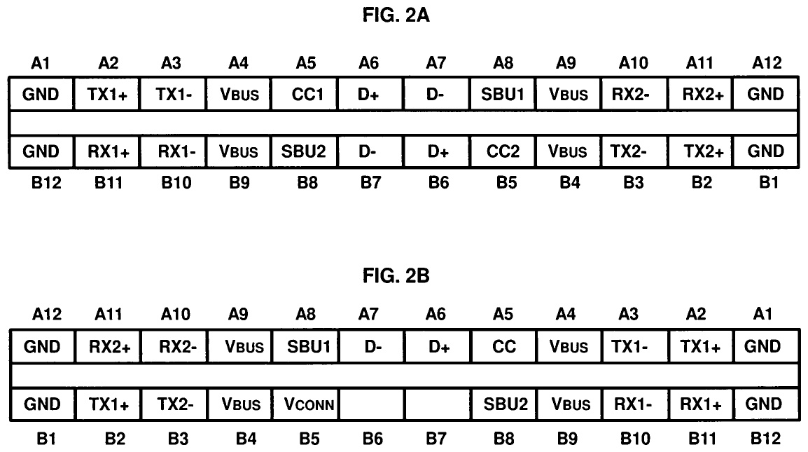

As a symmetrical and reversible connector, a Type-C connector has symmetrical A and B side layout pins as shown in FIG. 2A. A full featured Type-C plug interface, as shown in FIG. 2B, can represent a docking station situation. The receptacle side may represent a system; e.g., a notebook computer, for example, while the plug side may represent a docking station. In an example, the receptacle side may refer to the first electrical device 45 or the second electrical device 50, and the plug side may represent the electrical connector pins 20 of the two-fold rotationally-symmetrical electrical connector 15, as described above with reference to FIG. 1. The receptacle side and the plug side may be connected through the two-fold rotationally-symmetrical electrical connector 15, for example. Moreover, the two-fold rotationally-symmetrical electrical connector 15 may comprise electrical connector pins 20 on both ends of the two-fold rotationally-symmetrical electrical connector 15 to engage the first electrical device 45 and the second electrical device 50.

After the two-fold rotationally-symmetrical electrical connector 15 is mated; i.e., the two-fold rotationally-symmetrical electrical connector 15 on the plug side and a corresponding two-fold rotationally-symmetrical electrical connector 15 containing a set of complementary electrical pins on the receptacle side, a subset of pins of the electrical connector pins 20 of the two-fold rotationally-symmetrical electrical connector 15 are not utilized for transmission of electrical signals 35, and hence power delivery to the receptacle side. In an example, the subset of pins may be at least two pins, which may be located either at positions A7/A6 or B7/B6 on the receptacle connector depending on the plug orientation. When the two unused pins are repurposed as VBUS power pins, the aforementioned Type-C power delivery bottleneck can be alleviated for higher power delivery between the docking station and system; i.e., between the plug side and the receptacle side.

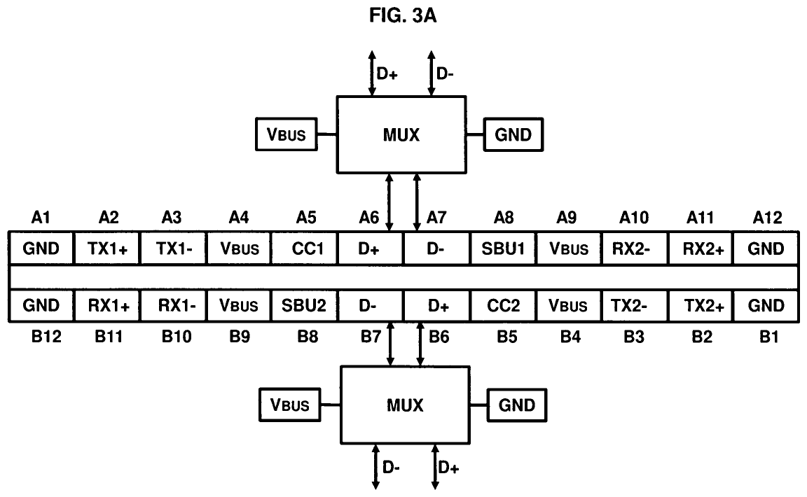

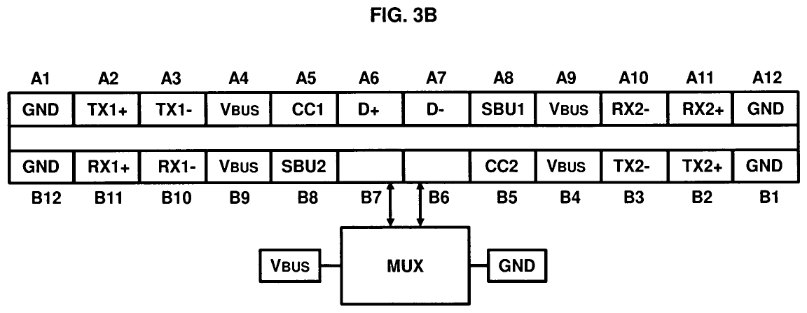

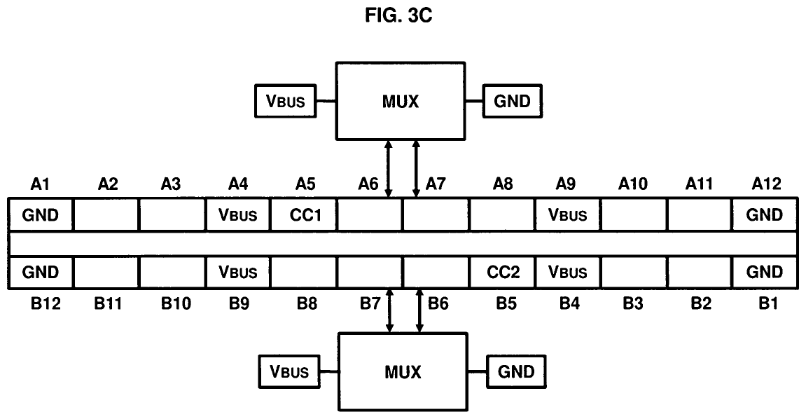

One example way to accomplish this is adding two MUXs shown in FIGS. 3A and 3B on both connectors; e.g., two-fold rotationally-symmetrical electrical connector 15 and a corresponding two-fold rotationally-symmetrical electrical connector 15 on any of the first electrical device 45 and the second electrical device 50. Accordingly, the switch 25 comprises a multiplexer, MUX, as shown in FIGS. 3A and 3B, with reference to FIGS. 1 through 2B. This type of connection makes the A7/A6 and B7/B6 pins connection flexible to be either power VBUS, ground, or USB D+/D− connection. The final connection is controlled by the power delivery controller 30 via an I2C interface after the link property is discovered; e.g., once the first electrical device 45 and the second electrical device 50 are connected by the two-fold rotationally-symmetrical electrical connector 15 and the first electrical device 45 and the second electrical device 50 communicate with one another to establish a communicative link therebetween.

An example of the sequence of operation includes: Before connection, two MUXs on the receptacle side for pin A7/8 and B7/8 are set as USB D+ or D−. The same occurs on the plug side where one MUX is used as USB D+ and D− and the other MUX is connected to nothing. With such an arrangement, subsequent power delivery link communication is the same as a normal power delivery configuration. Once a power delivery link finishes negotiation for communication between the first electrical device 45 and the second electrical device 50 and the CC location is known, the controller 30 on the receptacle side knows its B6/B7 (or A6/A7) pins are not being used. Thus, the power delivery controller 30 sends a command signal to pin B6/7's MUX connection from D+/D− to VBUS power, while no change occurs to pin A6/7's MUX.

After that, the power delivery controller 30 associated with the first electrical device 45 may sends a type-C “vendor defined electronic communication message” via the CC line to ask a power delivery controller on the other side (plug side) to set its B6/7 (A6/7) two pins MUX to VBUS power. On the other side of the Type-C cable, the plug side's power delivery controller receives a CC command. The plug side controller complies and changes its B6/7 MUX connection to VBUS from NC.

Once both controllers successfully set their MUX connection to VBUS, VBUS is connected on 6 pins on type-C connectors. With 4-6 pins for VBUS connection, the power delivery on VBUS increases by 50%.

The above shows ˜50% power delivery improvement on a full featured Type-C interface. That means a potentially ˜50% power delivery improvement from dock station to system, ˜150 W range. Unlike the dock station situation, a Type-C AC adapter does not require full feature Type-C interface, and its plug interface is much simplified and shown in FIG. 3C.

With no USB2.0 at all, all four pins A6/A7 and B6/B7 can be used as power pins. The sequence is that, once the power delivery configuration is completed, the receptacle power delivery controller 30 on the system side switches both MUXs to VBUS (from D+/D−). Then, the power delivery controller 30 sends a type-C “vendor defined electronic communication message” via the CC line to the controller on other side to configure its two MUXs to VBUS connection. Once the first electrical device 45 and the second electrical device 50 are communicatively linked, 8 pins are utilized for VBUS pin connection on the link. That means twice the power increase for Type-C configurations, which means a much higher power delivery adapter can be implemented to support mobile workstations.

Moreover, the Type-C AC adapter has more unused pins on its interface, some relatively low-speed signals, such as transmitted through SBU pins are not connected pins. Therefore, if more MUXs are added on the receptacle and plug sides, it can support far more power delivery than conventional techniques.

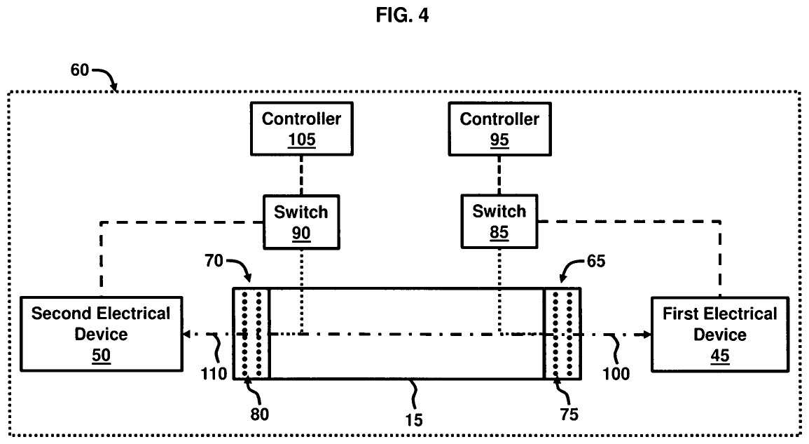

FIG. 4, with reference to FIGS. 1 through 3C, is a block diagram illustrating a power delivery device 60 comprising a two-fold rotationally-symmetrical electrical connector 15 comprising a first end 65 and a second end 70. In an example, the first end 65 and the second end 70 are positioned on diametrically opposite sides of the two-fold rotationally-symmetrical electrical connector 15. In an example, the two-fold rotationally-symmetrical electrical connector 15 comprises a first set of electrical connector pins 75 positioned at the first end 65, and a second set of electrical connector pins 80 positioned at the second end 70. The first set of electrical connector pins 75 and the second set of electrical connector pins 80 may be any type of male and female type metal pins used to connect to corresponding female or male ports in a corresponding connector, bridge device, or receptacle of an electrical device. Moreover, there may be any suitable number of electrical connector pins in the first set of electrical connector pins 75 and the second set of electrical connector pins 80 in the two-fold rotationally-symmetrical electrical connector 15. According to an example, the arrangement of the first set of electrical connector pins 75 is symmetrical to an arrangement of the second set of electrical connector pins 80.

A first switch 85 is operatively connected to the first set of electrical connector pins 75, and a second switch 90 is operatively connected to the second set of electrical connector pins 80. In an example, the first switch 85 and the second switch 90 may each be an electrical circuit that may be programmed and controlled using any of analog and digital electrical signals to control operation of the two-fold rotationally-symmetrical electrical connector 15. According to some examples, any of the first switch 85 and the second switch 90 may each be a standalone component or may be part(s) of another system(s) or device(s), such as a first electrical device 45 or a second electrical device 50.

The power delivery device 60 comprises a first power delivery controller 95 to (i) identify the first set of electrical connector pins 75 being used for transmission of electrical signals 100, and (ii) control the first switch 85 for power delivery to a first electrical device 45 connected at the first end 65. Furthermore, the power delivery device 60 comprises a second power delivery controller 105 to (i) identify the second set of electrical connector pins 80 being used for transmission of electrical signals 110, and (ii) control the second switch 90 for power delivery to a second electrical device 50 connected at the second end 70. According to an example electrical signals 100 and electrical signals 110 may be the same electrical signals. In an example, any of the first power delivery controller 95 and the second power delivery controller 105 may be an electrical circuit that may be programmed and controlled using any of analog and digital electrical signals to control operation of the first switch 85 and the second switch 90, respectively. According to some examples, the first power delivery controller 95 and the second power delivery controller 105 may each be a standalone component or may be part of another system(s) or device(s), such as the first electrical device 45 or the second electrical device 50, respectively. In some examples, the first power delivery controller 95 and the second power delivery controller 105 may be a central processing unit, microprocessor, microcontroller, PD controller, PID controller, hardware engine, hardware pipeline, and/or other hardware-enabled device suitable for receiving, processing, and operating a set of computer-implemented instructions used to control the first switch 85 and the second switch 90, respectively.

The electrical signals 100, 110 may be any type of electrical signals that are transmitted through the two-fold rotationally-symmetrical electrical connector 15, and which can deliver power to an electrical device, such as the first electrical device 45 and the second electrical device 50. For example, the electrical signals 100, 110 may be AC or DC signals. The first set of electrical connector pins 75 and the second set of electrical connector pins 80 are provided to transmit the electrical signals 100, 110 to/from the two-fold rotationally-symmetrical electrical connector 15 to a connected device, such as the first electrical device 45 and/or the second electrical device 50, respectively. The first power delivery controller 95 and the second power delivery controller 105 may be programmed to identify the first set of electrical connector pins 75 and the second set of electrical connector pins 80, respectively, being used for transmission of electrical signals 100, 110 based on whether electrical signals 100, 110 are transmitted through particular ones of the first set of electrical connector pins 75 and the second set of electrical connector pins 80. For example, when electrical signals 100, 110 are transmitted through some of the first set of electrical connector pins 75 and the second set of electrical connector pins 80, then the first power delivery controller 95 and the second power delivery controller 105 may detect which of the first set of electrical connector pins 75 and the second set of electrical connector pins 80, respectively, are transmitting the electrical signals 100, 110. In an example, the first power delivery controller 95 and the second power delivery controller 105 may utilize one or more sensors, not shown, to detect the electrical impulses associated with the electrical signals 100, 110. Additionally, the first power delivery controller 95 and the second power delivery controller 105 may be programmed to control the first switch 85 and the second switch 90, respectively, to open or close to deliver power between the first electrical device 45 and the second electrical device 50 via the two-fold rotationally-symmetrical electrical connector 15 and through the first set of electrical connector pins 75 and the second set of electrical connector pins 80 including any unused pins. For example, when control the first switch 85 and the second switch 90, respectively, is opened by the first power delivery controller 95 and the second power delivery controller 105, the electrical signals 100, 110 may be transmitted through the first set of electrical connector pins 75 and the second set of electrical connector pins 80.

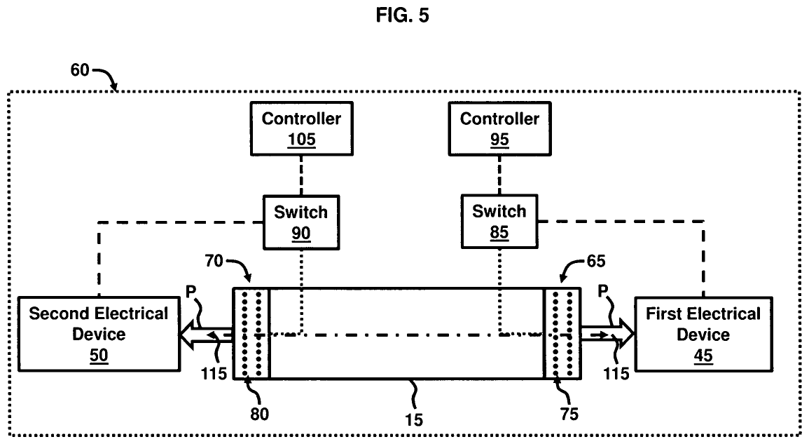

FIG. 5, with reference to FIGS. 1 through 4, illustrates that the first power delivery controller 95 may modify the first switch 85 from transmission of a differential electrical signal 115 to transmission of power P. Moreover, the second power delivery controller 105 may modify the second switch 90 from transmission of the differential electrical signal 115 to transmission of power P. A differential electrical signal 115 may be used in the context of a computer workstation system arrangement in order to reduce electromagnetic interference in the system. In an example, the differential electrical signal 115 may be the electrical signals 100, 110. The first power delivery controller 95 and the second power delivery controller 105 may modify the operations of the first switch 85 and the second switch 90, respectively, to deliver power P to the respective first electrical device 45 and the second electrical device 50. This may occur by opening/closing the first switch 85 and the second switch 90, for example. Modifying the operations of the first switch 85 and the second switch 90 may permit the first set of electrical connector pins 75 and the second set of electrical connector pins 80 to be fully utilized to increase the amount of power P that is transmitted through the two-fold rotationally-symmetrical electrical connector 15.

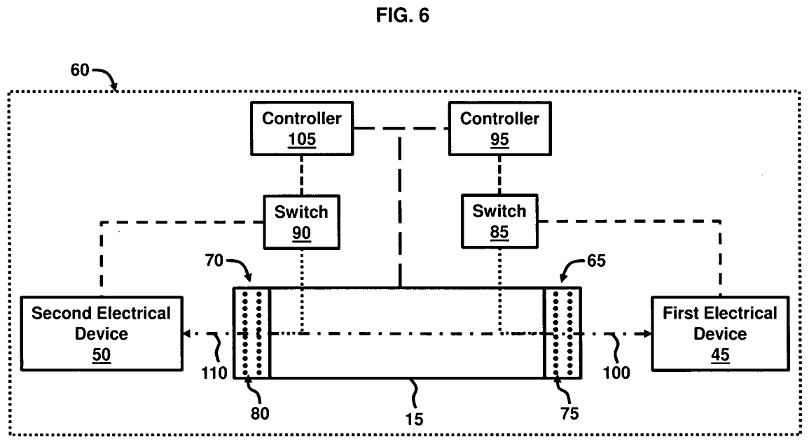

FIG. 6, with reference to FIGS. 1 through 5, illustrates that the first power delivery controller 95 and the second power delivery controller 105 are communicatively linked through the two-fold rotationally-symmetrical electrical connector 15. Accordingly, the first power delivery controller 95 and the second power delivery controller 105 may communicate with one another by transmitting electronic communications, as further described below, in order to link operations of the first electrical device 45 and the second electrical device 50. By linking operations of the first electrical device 45 and the second electrical device 50, the first power delivery controller 95 and the second power delivery controller 105 may control the operations of the first switch 85 and the second switch 90, respectively, in order to fully utilize the first set of electrical connector pins 75 and the second set of electrical connector pins 80.

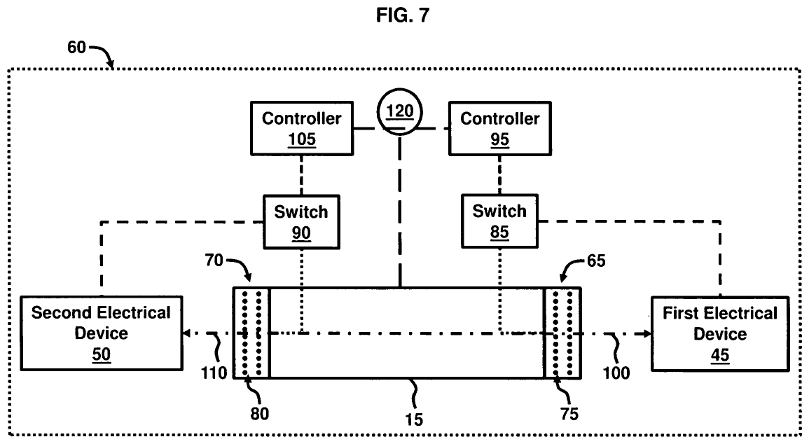

FIG. 7, with reference to FIGS. 1 through 6, illustrates that the first power delivery controller 95 and the second power delivery controller 105 are to exchange computer-executable instructions 120 with one another to determine whether the first electrical device 45 and the second electrical device 50 are operationally compatible with each other. The first electrical device 45 and the second electrical device 50 may comprise operational parameters stored as computer code, for example, that are transmitted in the computer-executable instructions 120. The first power delivery controller 95 and the second power delivery controller 105 may be programmed to read the computer-executable instructions 120 containing the operational parameters to determine whether the first electrical device 45 and the second electrical device 50 are operationally compatible with each other.

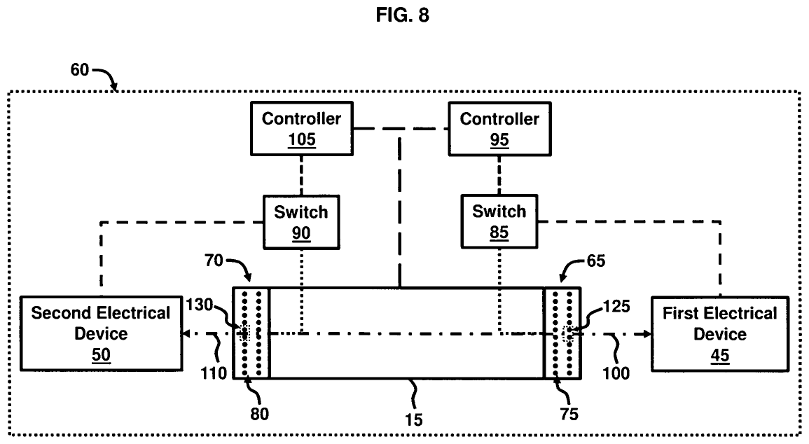

FIG. 8, with reference to FIGS. 1 through 7, illustrates that the first power delivery controller 95 is to identify a subset of pins 125 of the first set of electrical connector pins 75 that are not being used for transmission of the electrical signals 100, and deliver power through the subset of pins 125. Moreover, the second power delivery controller 105 is to identify a subset of pins 130 of the second set of electrical connector pins 80 that are not being used for transmission of the electrical signals 100, 110, and deliver power through the subset of pins 130. In an example, the first power delivery controller 95 and the second power delivery controller 105 may each accomplish this by detecting the absence of electrical signals 100, 110 being transmitted through the subset of pins 125, 130, respectively. Additionally, the first power delivery controller 95 and the second power delivery controller 105 each may be programmed to control the first switch 85 and the second switch 90 to open or close to deliver power between the first electrical device 45 and the second electrical device 50 via the two-fold rotationally-symmetrical electrical connector 15 and through the first set of electrical connector pins 75 including the subset of pins 125 and the second set of electrical connector pins 80 including the subset of pins 130. For example, when the first switch 85 and the second switch 90 are opened by the first power delivery controller 95 and the second power delivery controller 105, respectively, the electrical signals 100, 110 may be transmitted through the first set of electrical connector pins 75 and the second set of electrical connector pins 80 including the subset of pins 125 and the subset of pins 130 that previously; i.e., when the first switch 85 and second switch 90 are closed, were not transmitting the electrical signals 100, 110, respectively. Accordingly, power delivery occurs by the transmission of the electrical signals 100, 110 through the first set of electrical connector pins 75 and the second set of electrical connector pins 80 including the subset of pins 125, 130. Because electrical signals 100, 110 are also being delivered through the subset of pins 125, 130, the amount of delivered power increases compared to when electrical signals 100, 110 are delivered through the first set of electrical connector pins 75 and the second set of electrical connector pins 80 but not through the subset of pins 125, 130.

Various examples described herein may include both hardware and software elements. The examples that are implemented in software may include firmware, resident software, microcode, etc. Other examples may include a computer program product configured to include a pre-configured set of instructions, which when performed, may result in actions as stated in conjunction with the methods described above. In an example, the preconfigured set of instructions may be stored on a tangible non-transitory computer readable medium or a program storage device containing software code.

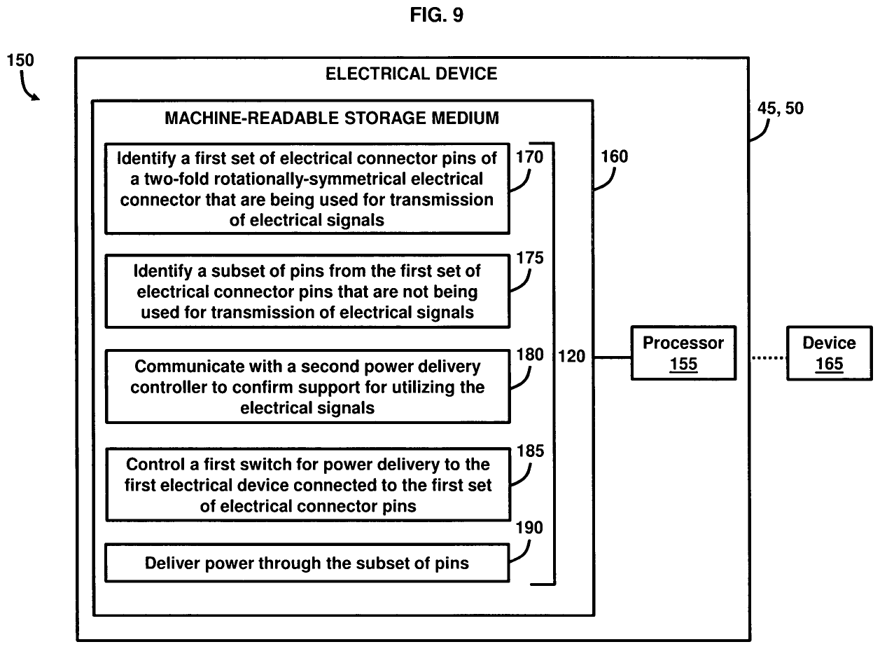

FIG. 9, with reference to FIGS. 1 through 8, illustrates an example system 150 to manage power delivery to a first electrical device 45 or a second electrical device 50. In the example of FIG. 9, the first electrical device 45 and/or the second electrical device 50 includes a processor 155 and a machine-readable storage medium 160. Processor 155 may include a central processing unit, microprocessors, hardware engines, and/or other hardware devices suitable for retrieval and execution of instructions stored in a machine-readable storage medium 160. Processor 155 may fetch, decode, and execute computer-executable instructions 120 to enable execution of locally-hosted or remotely-hosted applications for controlling action of the first power delivery controller 95 of the first electrical device 45 or the second power delivery controller 105 of the second electrical device 50. The remotely-hosted applications may be accessible on remotely-located devices; for example, remote communication device 165. For example, the remote communication device 165 may be a computer, tablet device, smartphone, or remote server. As an alternative or in addition to retrieving and executing instructions, processor 155 may include electronic circuits including a number of electronic components for performing the functionality of the computer-executable instructions 120.

The machine-readable storage medium 160 may be any electronic, magnetic, optical, or other physical storage device that stores executable instructions. Thus, the machine-readable storage medium 160 may be, for example, Random Access Memory, an Electrically-Erasable Programmable Read-Only Memory, volatile memory, non-volatile memory, flash memory, a storage drive (e.g., a hard drive), a solid-state drive, optical drive, any type of storage disc (e.g., a compact disc, a DVD, etc.), and the like, or a combination thereof. In one example, the machine-readable storage medium 160 may include a non-transitory computer-readable storage medium 160. The machine-readable storage medium 160 may be encoded with executable instructions for enabling execution of remotely-hosted applications accessed on the remote communication device 165.

In an example, the processor 155 of the first electrical device 45 or the second electrical device 50 executes the computer-executable instructions 120. The computer-executable instructions 120 comprise instructions 170, 175, 180, 185, and 190. Identifying instructions 170 identify a first set of electrical connector pins 75 of a two-fold rotationally-symmetrical electrical connector 15 that are being used for transmission of electrical signals 100. In an example, the two-fold rotationally-symmetrical electrical connector 15 may be a Type-C connector. The first set of electrical connector pins 75 may be any type of male and female type metal pins used to connect to corresponding female or male ports in a corresponding connector, bridge device, or receptacle of an electrical device. Moreover, there may be any suitable number of electrical connector pins in the first set of electrical connector pins 75 in the two-fold rotationally-symmetrical electrical connector 15. The electrical signals 100 may be any type of electrical signals that are transmitted through the two-fold rotationally-symmetrical electrical connector 15, and which can deliver power to an electrical device, such as the first electrical device 45. For example, the electrical signals 100 may be AC or DC signals.

Identifying instructions 175 identify a subset of pins 125 from the first set of electrical connector pins 75 that are not being used for transmission of electrical signals 100. For example, when electrical signals 100 are transmitted through some of the first set of electrical connector pins 75, then the processor 155 or first power delivery controller 95 may detect which of the first set of electrical connector pins 75 are transmitting the electrical signals 100. In an example, the processor 155 or first power delivery controller 95 may utilize one or more sensors, not shown, to detect the electrical impulses associated with the electrical signals 100. Furthermore, the processor 155 or the first power delivery controller 95 may be programmed to identify a subset of pins 125 of the first set of electrical connector pins 75 that are not being used for transmission of the electrical signals 100. In an example, the processor 155 or first power delivery controller 95 may accomplish this by detecting the absence of electrical signals 100 being transmitted through the subset of pins 125.

Communicating instructions 180 communicate with a second power delivery controller 105 to confirm support for utilizing the electrical signals 100, 110. In this regard, the processor 155 may facilitate the communication between the first power delivery controller 95 and the second power delivery controller 105 to confirm the support utilizing the electrical signals 100, 110 to to ensure the first electrical device 45 and a second electrical device 50 are operationally compatible with one another. Once confirmation occurs, then the first power delivery controller 95 and the first electrical device 45 is communicatively and operationally linked with the second power delivery controller 105 and the second electrical device 50.

Controlling instructions 185 control a first switch 85 for power delivery to the first electrical device 45 connected to the first set of electrical connector pins 75. In an example, the first switch 85 may be an electrical circuit that may be programmed and controlled using any of analog and digital electrical signals to control operation of the two-fold rotationally-symmetrical electrical connector 15. The processor 155 or the first power delivery controller 95 may be programmed to identify the first set of electrical connector pins 75 being used for transmission of electrical signals 100 based on whether electrical signals 100 are transmitted through particular the first set of electrical connector pins 75. For example, when electrical signals 100 are transmitted through some of the first set of electrical connector pins 75, then the processor 155 or the first power delivery controller 95 may detect which of the first set of electrical connector pins 75 are transmitting the electrical signals 100. In an example, the processor 155 or the first power delivery controller 95 may utilize one or more sensors, not shown, to detect the electrical impulses associated with the electrical signals 100. Furthermore, the processor 155 or the first power delivery controller 95 may be programmed to identify a subset of pins 125 of the first set of electrical connector pins 75 that are not being used for transmission of the electrical signals 100. In an example, the processor 155 or the first power delivery controller 95 may accomplish this by detecting the absence of electrical signals 100 being transmitted through the subset of pins 125.

Delivering instructions 190 deliver power through the subset of pins 125. The processor 155 or the first power delivery controller 95 may be programmed to control the first switch 85 to open or close to deliver power between the first electrical device 45 and the second electrical device 50 via the two-fold rotationally-symmetrical electrical connector 15 and through the first set of electrical connector pins 75 including the subset of pins 125. For example, when the first switch 85 is opened by the processor 155 or the first power delivery controller 95, the electrical signals 100 may be transmitted through the first set of electrical connector pins 75 including the subset of pins 125 that previously; i.e., when the first switch 85 is closed, were not transmitting the electrical signals 100. Accordingly, power delivery occurs by the transmission of the electrical signals 100 through the first set of electrical connector pins 75 including the subset of pins 125. Because electrical signals 100 are also being delivered through the subset of pins 125, the amount of delivered power increases compared to when electrical signals 100 are delivered through the first set of electrical connector pins 75 but not through the subset of pins 125.

The instructions 120, when executed, further cause the second power delivery controller 105 to identify a second set of electrical connector pins 80 of the two-fold rotationally-symmetrical electrical connector 15 that are being used for transmission of the electrical signals 110. The processor 155 or the second power delivery controller 105 may be programmed to identify the second set of electrical connector pins 80 being used for transmission of electrical signals 110 based on whether electrical signals 110 are transmitted through particular the second set of electrical connector pins 80. For example, when electrical signals 110 are transmitted through some of the second set of electrical connector pins 80, then the processor 155 or the second power delivery controller 105 may detect which of the second set of electrical connector pins 80 are transmitting the electrical signals 110. In an example, the processor 155 or the second power delivery controller 105 may utilize one or more sensors, not shown, to detect the electrical impulses associated with the electrical signals 110. Furthermore, the processor 155 or the second power delivery controller 105 may be programmed to identify a subset of pins 130 of the second set of electrical connector pins 80 that are not being used for transmission of the electrical signals 110. In an example, the processor 155 or the second power delivery controller 105 may accomplish this by detecting the absence of electrical signals 110 being transmitted through the subset of pins 130.

The instructions 120, when executed, further cause the second power delivery controller 105 to control a second switch 90 for increasing power delivery to a second electrical device 50 connected to the second set of electrical connector pins 80. The processor 155 or the second power delivery controller 105 may be programmed to control the second switch 90 to open or close to deliver power between the first electrical device 45 and the second electrical device 50 via the two-fold rotationally-symmetrical electrical connector 15 and through the second set of electrical connector pins 80 including the subset of pins 130. For example, when the second switch 90 is opened by the processor 155 or the second power delivery controller 105, the electrical signals 110 may be transmitted through the second set of electrical connector pins 80 including the subset of pins 130 that previously; i.e., when the second switch 90 is closed, were not transmitting the electrical signals 110. Accordingly, power delivery occurs by the transmission of the electrical signals 110 through the second set of electrical connector pins 80 including the subset of pins 130. Because electrical signals 110 are also being delivered through the subset of pins 130, the amount of delivered power increases compared to when electrical signals 110 are delivered through the second set of electrical connector pins 80 but not through the subset of pins 130.

The present disclosure has been shown and described with reference to the foregoing exemplary implementations. Although specific examples have been illustrated and described herein it is manifestly intended that the scope of the claimed subject matter be limited only by the following claims and equivalents thereof. It is to be understood, however, that other forms, details, and examples may be made without departing from the spirit and scope of the disclosure that is defined in the following claims.

What is claimed is:

1. A power delivery device comprising:
a two-fold rotationally-symmetrical electrical connector comprising electrical connector pins having power delivery capability;
a switch operatively connected to the two-fold rotationally-symmetrical electrical connector to transmit power through the electrical connector pins; and
a power delivery controller to (i) identify a first set of electrical connector pins being used for transmission of electrical signals, (ii) identify a second set of electrical connector pins that are not being used for transmission of the electrical signals, and (iii) control the switch for power delivery between a first electrical device and a second electrical device through the first set of electrical connector pins and the second set of electrical connector pins.

2. The power delivery device of claim 1, wherein the two-fold rotationally-symmetrical electrical connector comprises a reversible connector.

3. The power delivery device of claim 1, wherein the two-fold rotationally-symmetrical electrical connector comprises a Type-C connector.

4. The power delivery device of claim 1, wherein the switch comprises a multiplexer.

5. The power delivery device of claim 1, wherein the power delivery is greater than 100 W.

6. A power delivery device comprising:
a two-fold rotationally-symmetrical electrical connector comprising a first end and a second end, wherein the two-fold rotationally-symmetrical electrical connector comprises:
a first set of electrical connector pins positioned at the first end; and
a second set of electrical connector pins positioned at the second end;
a first switch operatively connected to the first set of electrical connector pins;
a second switch operatively connected to the second set of electrical connector pins;
a first power delivery controller to (i) identify the first set of electrical connector pins being used for transmission of electrical signals, and (ii) control the first switch for power delivery to a first electrical device connected at the first end; and
a second power delivery controller to (i) identify the second set of electrical connector pins being used for transmission of electrical signals, and (ii) control the second switch for power delivery to a second electrical device connected at the second end.

7. The power delivery device of claim 6, wherein the first power delivery controller is to modify the first switch from transmission of a differential electrical signal to transmission of power, and wherein the second power delivery controller is to modify the second switch from transmission of the differential electrical signal to transmission of power.

8. The power delivery device of claim 6, wherein an arrangement of the first set of electrical connector pins is symmetrical to an arrangement of the second set of electrical connector pins.

9. The power delivery device of claim 6, wherein the first power delivery controller and the second power delivery controller are communicatively linked through the two-fold rotationally-symmetrical electrical connector.

10. The power delivery device of claim 9, wherein the first power delivery controller and the second power delivery controller are to exchange computer-executable instructions to determine whether the first electrical device and the second electrical device are operationally compatible with each other.

11. The power delivery device of claim 6, wherein the first power delivery controller is to identify a subset of pins of the first set of electrical connector pins that are not being used for transmission of the electrical signals, and deliver power through the subset of pins.

12. The power delivery device of claim 6, wherein the second power delivery controller is to identify a subset of pins of the second set of electrical connector pins that are not being used for transmission of the electrical signals, and deliver power through the subset of pins.

13. A machine-readable storage medium comprising computer-executable instructions that when executed cause a first power delivery controller of a first electrical device to:
identify a first set of electrical connector pins of a two-fold rotationally-symmetrical electrical connector that are being used for transmission of electrical signals;
identify a subset of pins from the first set of electrical connector pins that are not being used for transmission of electrical signals;
communicate with a second power delivery controller to confirm support for utilizing the electrical signals;
control a first switch for power delivery to the first electrical device connected to the first set of electrical connector pins; and
deliver power through the subset of pins.

14. The machine-readable storage medium of claim 13, wherein the instructions, when executed, further cause the second power delivery controller to identify a second set of electrical connector pins of the two-fold rotationally-symmetrical electrical connector that are being used for transmission of the electrical signals.

15. The machine-readable storage medium of claim 14, wherein the instructions, when executed, further cause the second power delivery controller to control a second switch for increasing power delivery to a second electrical device connected to the second set of electrical connector pins.
